(19) United States
(12) Patent Application Publication
(10) Pub. No.: US 2025/0279743 A1
(43) Pub. Date: Sep. 4, 2025

(54) SOLAR MAINTENANCE CHARGER

(71) Applicant: Caterpillar Inc., Peoria, IL (US)

(72) Inventors: Umesh B S, Tumkur (IN); Aravinth MANIVANNAN, Bengaluru, Karnataka (IN); Karthikeyan KOTTAISAMY, Sayalkudi (IN)

(73) Assignee: Caterpillar Inc., Peoria, IL (US)

(21) Appl. No.: 18/593,539

(22) Filed: Mar. 1, 2024

(51) Int. Cl. H02S 10/20; B60L 53/51; H02J 3/38; H02J 7/35; H02S 10/40; H02S 30/20

(52) U.S. Cl. CPC H02S 10/20; B60L 53/51; H02J 3/38; H02J 7/35; H02S 10/40; H02J 2207/20; H02J 2300/26; H02S 30/20

(57) ABSTRACT

A solar maintenance charging kit may include a solar panel assembly, an auxiliary battery system configured to receive power from the solar panel assembly, and an electronics assembly configured to adjust a maintenance voltage supplied to a mobile industrial machine from one of the solar panel assembly or the auxiliary battery system. The solar maintenance charging kit may be portable.

### TECHNICAL FIELD

The present disclosure relates generally to one or more aspects of a charging system, and more particularly, to systems and methods of solar maintenance charging.

### BACKGROUND

Rechargeable batteries, such as lithium-ion batteries, self-discharge at the rate of approximately 5% per month. Mobile electric industrial machines may experience periods of extended downtime (e.g., awaiting job assignments) during which the batteries of the electric vehicle are self-discharging despite not being used. The relatively low rate of self-discharge means that corresponding compensation power may be of comparatively low power as compared to mainstream charging implementations (e.g., DC fast charging) in order to keep batteries appropriately charged for future use. Mainstream charging implementations (e.g., DC and onboard charging), provide far greater power than is required to compensate for self-discharging. These existing charging implementations (for example, in heavy industry) carry a high base parasitic power requirement for the battery system of the machine to receive even small amounts of power from existing charging implementations. Parasitic power may be generally understood as power required to actuate cooling and other auxiliary systems during DC and/or onboard charging of a battery system. Parasitic power requirements occur purely on the machine side of a charging implementation. Existing charging implementations are also typically unavailable in remote (e.g., off-grid) locations where heavy industry machines are often used. Accordingly, there is a need for more efficient maintenance charging of heavy duty electric machines, for example, in off-grid locations.

Chinese Patent Utility Model Patent No. CN207382225U (“the '225 patent”) discloses a portable solar power charging device for automobiles. The charging device has a flexible solar cell panel, a DC-AC converter for transforming direct current into alternating current, a battery for storing energy, and an AC charging device for charging electric vehicles. The flexible solar cell panel may charge the battery. However, the '225 patent may not address the parasitic power requirements of large electric machines.

The techniques of the present disclosure may solve one or more of the problems set forth above and/or other problems in the art. The scope of the current disclosure, however, is provided by the attached claims, and not by the ability to solve any specific problem.

### SUMMARY

In one aspect, a solar maintenance charging kit may include a solar panel assembly, an auxiliary battery system configured to receive power from the solar panel assembly, and an electronics assembly configured to adjust a maintenance voltage supplied to a mobile industrial machine from one of the solar panel assembly or the auxiliary battery system. The solar maintenance charging kit may be portable.

In another aspect, a method for selectively charging a battery pack of a mobile industrial machine (MIM) with a solar maintenance charger (SMC). The SMC may include a solar panel assembly, an electronics assembly, and an auxiliary battery system. The SMC may be portable. The method may further include connecting the SMC to the MIM via an electrical connector, transmitting handshake information between the SMC and the MIM, enabling a maintenance charging mode at the MIM, transmitting a power request from the MIM to the SMC, activating an electrical control unit at the SMC, and disabling one or more parasitic power requirements of charging the battery pack. The disabling may further include disabling a battery cooling system of the MIM.

In still another aspect, a method may include electrically connecting a solar maintenance charger (SMC) to a mobile industrial machine (MIM). The SMC may include a solar panel assembly, a first DC-DC converter, configured to convert power from the solar panel assembly from a first voltage to a second voltage, a charging connector, and a DC-AC converter, configured to convert power received from the first converter at the second voltage to a third voltage, transmitting handshake information between the SMC and the MIM, enabling a maintenance charging mode at the MIM, transmitting a power request from the MIM to the SMC, activating an electrical control unit at the SMC, and supplying, based on the power request, current from the solar panels to the MIM. The supplied current from the solar panel assembly to the MIM may be at the third voltage.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates the use of the solar maintenance charger with a mobile, electric industrial machine, according to aspects of the disclosure.

FIG. 2 is a schematic view of components of the solar maintenance charger of FIG. 1.

FIG. 3 provides a flowchart of an exemplary operational method of the solar maintenance charger of FIG. 1.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

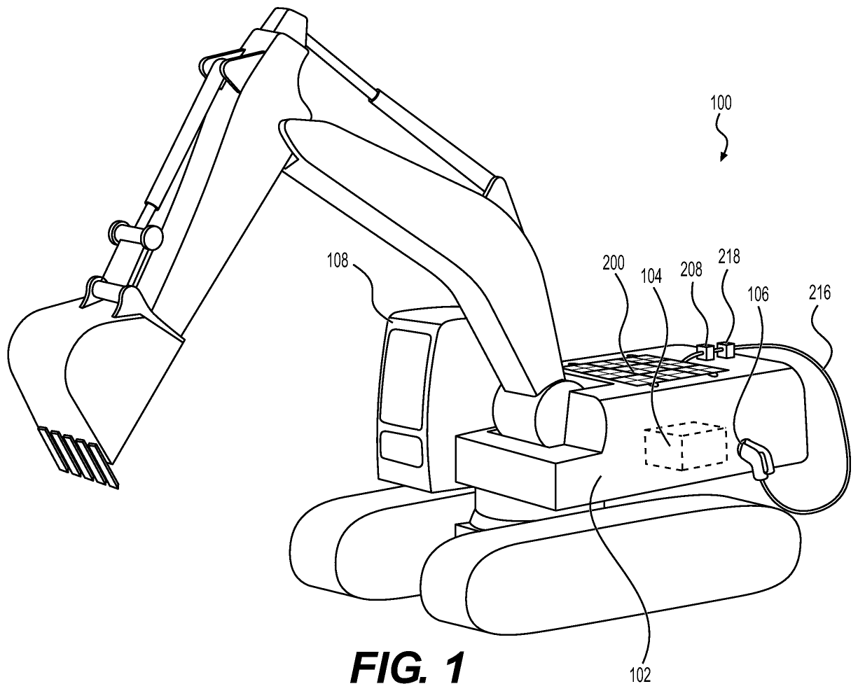

FIG. 1 illustrates a charging arrangement 100, according to aspects of the disclosure. Charging arrangement 100 may include a solar maintenance charger (SMC) 200 electrically connected to a battery-powered mobile industrial machine (MIM) 102, though this is only exemplary. Throughout this disclosure, SMCs may also be referred to as chargers, and MIMs may also be referred to as machines, unless otherwise noted. It will be understood that charging arrangement 100 may be implemented in any suitable machine that receives sufficient sunlight to energize photovoltaic (PV) panels and requires maintenance charging. While it is contemplated that the exemplary embodiments may be applied to a machine such as an excavator as shown in FIG. 1, one of ordinary skill in the art will appreciate that the examples and methods described herein may be applicable to any mobile industrial machine (e.g., a backhoe, an articulated truck, a dozer, a compactor) or system featuring rechargeable batteries (e.g., a consumer electric vehicle). The machine 102 may feature an all-electric drive system, or a partially-electric (hybrid) drive system.

PV panels may also be referred to as solar panels throughout this disclosure. An electrical connection between the charger 200 and the machine 102 may be via a connector 216. Connector 216 may allow the charger 200 to charge a primary battery system (PBS) 104 of machine 102. Charger 200 may feature an auxiliary battery system (ABS), which may be used to charge PBS 104 alone or in combination with solar power directly generated by charger 200. The ABS may also be referred to as an auxiliary battery throughout this disclosure, unless otherwise noted. Charger 200 may feature a controller 218 that may monitor voltages associated with auxiliary battery 208 and PBS 104 and prioritize either the auxiliary battery 208 or the PBS 104 for charging first, or the controller may allow both the auxiliary battery 208 and the PBS 104 to charge simultaneously.

Charger 200 may feature solar panels 202, which may comprise a plurality of solar cells that are capable of converting solar energy into electrical charge to charge PBS 104 and/or auxiliary battery 208. Solar panels 202 may be flexible and/or arranged in such a manner so that solar panels 202 are outwardly folded from a stored state to a deployed state. Solar panels 202 may be sized such that they may be stored in the cabin portion 108 of machine 102 when in the stored (e.g., folded) state. One of ordinary skill in the art will appreciate that amount of power needed to maintain a charge state of a given PBS may vary based on the capacity of the PBS. Accordingly, the number of solar panels present in solar panels 202 may be approximately equal to the number of solar panels required to prevent a given PBS from self-discharging (e.g., solar panels 202 provide power to PBS 104 greater than or equal to the power lost through self-discharging).

PBS 104 may be used to provide power for the various operations performed by machine 102 (e.g., powering the drivetrain, HVAC systems, and mechanical actuation systems). PBS 104 may contain one or more battery packs may each contain one or more modules, and the one or more modules may contain one or more cells (not shown in FIG. 1). One of ordinary skill in the art will appreciate that the packs, modules, and cells of PBS 104 may be arranged in various configurations (e.g., in number of packs/modules/cells).

Battery cells in PBS 104 may have any chemistry and construction. In some embodiments, the battery cells may have a lithium-ion chemistry. Lithium-ion chemistry comprises a family of battery chemistries that employ various combinations of anode and cathode materials. In automotive applications, these chemistries may include lithium-nickel-cobalt-aluminum (NCA), lithium-nickel-manganese-cobalt (NMC), lithium-manganese-spinel (LMO), lithium titanate (LTO), and lithium-iron phosphate (LFP), for example. In consumer applications, the battery chemistry may also include lithium-cobalt oxide (LCO), for example.

In general, the battery cells in PBS 104 may have any shape and structure (e.g., a cylindrical cell, a prismatic cell, a pouch cell, etc.). Typically, all the battery cells of a battery module may have the same shape. However, it is also contemplated that different shaped battery cells may be packed together. In addition to the battery cells, modules of PBS 104 may also include sensors (e.g., a temperature sensor, a voltage sensor, a humidity sensor, etc.) and controllers (e.g., a battery module controller) that monitor and control the operation of the battery cells. Although not illustrated, a battery module of PBS 104 may include electrical circuits (e.g., voltage and current sense lines, low voltage lines, high voltage lines, etc.), and related accessories (e.g., fuses, switches, etc.), that direct electrical current to and from the battery cells during recharging and discharging

PBS 104 may be primarily charged by electrically connecting machine 102 to a power source of sufficient voltage via a connector. In an example, an operator may electrically connect machine 102 to a power source, such as DC charging station via a combined charging system (CCS) connector mating with a charging port 106 of machine 102 (e.g., a CCS charging port). It should be understood that while this disclosure refers to a CCS connector and port, this is only exemplary, and any sufficient connection arrangement may be used with any of the exemplary embodiments.

The primary charging mentioned above may refer to charging the machine 102 after a period of use (e.g., during a time period in which the PBS 104 is being used to power one or more systems or operations of machine 102). In contrast, maintenance charging may refer to charging to maintain PBS 104 at a given voltage (e.g., charge capacity) for extended periods of idle time. Maintenance charging may require substantially less voltage and parasitic power requirements than primary charging implementations. While the exemplary embodiments refer to PV panels for providing power to a solar maintenance charger, one of ordinary skill in the art will appreciate that other renewable, off-grid energy sources could be adapted to power a maintenance charger, such as micro-wind turbines and micro-hydro turbines.

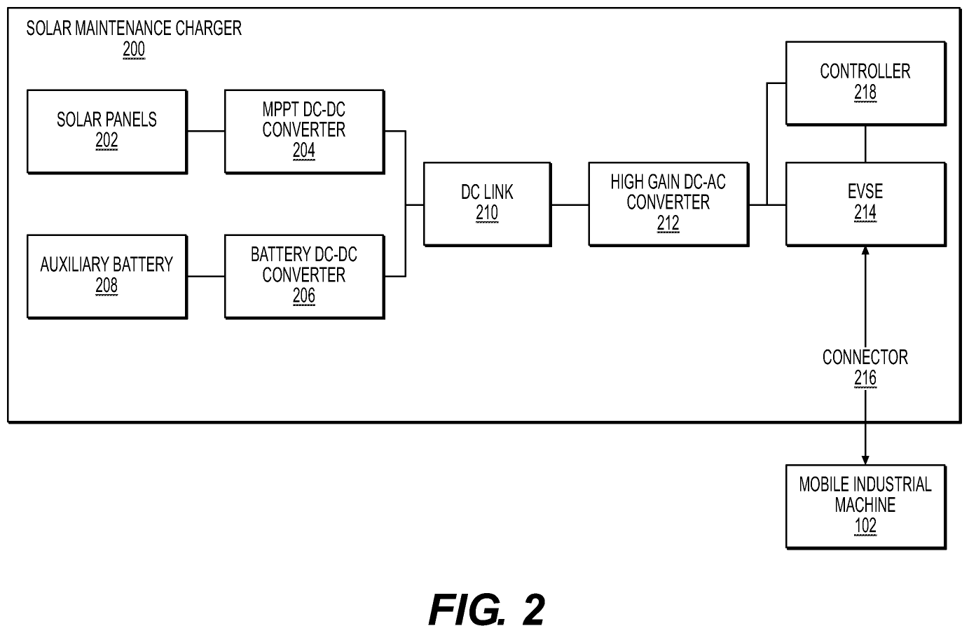

FIG. 2 shows a detailed view of solar maintenance charger (charger) 200, according to aspect of the disclosure. Charger 200 may be of a size capable of being stored within a cabin portion 108 of machine 102. The relatively small size of the charger 200 may enable operators to easily store and deploy the charger for a machine left in extended periods of downtime.

Electrically connected to solar panels 202 is maximum power point tracker (MPPT) DC-DC converter 204. The maximum power point may be visualized as the point at which the products of voltage (V) and current (I) are maximized. The electrical output of solar panels 202 may vary based on various factors such as solar azimuth, solar intensity, cloud cover, and temperature. MPPT DC-DC 204 may continuously adjust the electrical load to solar panels 202 such that maximum power (V×I) is maintained as the aforementioned solar power factors change. MPPT DC-DC converter 204 may also adjust DC power output from solar panels 202 from a first voltage (Vₚᵥ) to a second voltage (V_{dc}). As an example, Vₚᵥ may be approximately equal to 50 V to 100 V. V_{dc} may be approximately equal to 400 V to 600 V. Power at V_{dc} may be transmitted to high gain DC-AC converter 212 via a DC link 210.

In certain aspects of the exemplary embodiments, charger 200 may feature an auxiliary battery system 208 and a battery DC-DC converter 206. Power generated by solar panel 202 may be transmitted to MPPT DC-DC converter 204, then to battery DC-DC converter 206 at V_{dc}. Battery DC-DC converter 206 may convert V_{dc} to V_{Bat_Aux} (e.g., approximately 200 V to 300 V) to charge auxiliary battery system (auxiliary battery) 208. Auxiliary battery 208 may feature one or more battery packs containing one or more modules, the one or more modules containing one or more battery cells. Auxiliary battery 208 may feature the similar battery chemistry and/or cell geometry to PBS 104, though in some aspects auxiliary battery 208 may feature a different battery chemistry and/or cell geometry than PBS 104. Power may be transmitted from solar panels 202 to auxiliary battery 208 and/or DC link 210. Auxiliary battery 208 may provide power to DC link 210 at V_{dc}. Auxiliary battery 208 may feature a substantially smaller capacity as compared to the capacity of PBS 104. The relatively small capacity of auxiliary battery 208 may enhance the portability of charger 200 such that it may be stored in a compact state within a cabin 108 of machine 102.

Auxiliary battery 208 may transmit power to PBS 104 at V_{dc} to DC link 210 via Battery DC-DC converter 206, which may convert the voltage from V_{Bat_Aux} to V_{dc}. Auxiliary battery 208 may be charged during the day by solar panels 202. Auxiliary battery 208 may provide maintenance charging to PBS 104 at night or overcast days when solar panels 202 are unable to generate power sufficient to outpace the rate of self-discharge of PBS 104. Auxiliary battery 208 may charge PBS 104 alone or in combination with solar panels 202. Auxiliary battery 208 and solar panels 202 may provide power to DC link at V_{dc}. In some embodiments, controller 218 may monitor voltages associated with auxiliary battery 208 and PBS 104 and prioritize either the auxiliary battery 208 or the PBS 104 for charging first, or the controller may allow both the auxiliary battery 208 and the PBS 104 to charge simultaneously. It should be understood that auxiliary battery 208 and battery DC-DC converter may not be present in all aspects of the exemplary embodiments. That is, in some aspects without auxiliary battery 208, only solar panels 202 may charge PBS 104.

Solar panels 202 (via MPPT DC-DC converter 204) and/or auxiliary battery 208 (via battery DC-DC converter 206) may provide power at V_{dc} to DC link 210. DC link 210 may serve as a conduit through which power from sources (solar panels 202 and/or auxiliary battery 208) is transferred to high gain DC-AC Converter 212. DC link 210 may include components that provide voltage regulation and filtering of incoming power. This regulation and filtering may occur via one or more capacitors, which may smooth voltage fluctuations and provide a consistent voltage to high gain DC-AC converter 212.

High gain DC-AC converter 212 may convert steady and unidirectional direct current to alternating current, which varies in magnitude and direction. The high gain DC-AC converter 212 may also significantly increase the voltage (e.g., step up) of incoming power. The high gain DC-AC converter 212 may step up voltage at a ratio of 1:n, where ‘n’ is an integer such that the output voltage is compatible with a given electrical (e.g., CCS) connector.

Controller 218 may be informed of what type of CCS connector is in use with charger 200 (e.g., CCS-1, CCS-2) via EVSE 214, and vary the step-up ratio of high gain DC-AC converter 212. It should be understood that high-gain DC-AC converter 212 may, in some scenarios, only provide step-up functionality and may not convert incoming DC power to AC. This may be based on which type of CCS connector is connected to charger 200, the type of machine 102, and/or various conversion schemes applied via controller 218. Accordingly, high gain DC-AC converter 212 may output DC or AC power.

In an example, a CCS-2 connector may output at approximately 300 V to 1000 V DC. In another example, a CCS-1 connector may output 1-phase AC at approximately 120 V to 230 V. One of ordinary skill in the art will appreciate that CCS connectors may accept and output both AC and DC current. Accordingly, various conversion schemes from V_{dc} through high-gain DC-AC converter 212 are possible which may be applied via controller 218.

High-gain DC-AC converter 212 may be connector to electric vehicle supply equipment (EVSE) 214. EVSE 214 may be understood to refer to the hardware and software stack that enables charger 200 to provide maintenance charging to various CCS compatible machines. One of ordinary skill in the art will appreciate that a connector 216 (e.g., a CCS connector) may be a component of EVSE 214. EVSE 214 may include a processor and firmware, network connectivity (for example, a 5G and/or satellite connection), and various components used to identify the type of machine that connector 216 may be attached to (for example, a near-field communication (NFC) reader). EVSE 214 may communicate with charger 200 and machine 102 to coordinate charging output of charger 200 with charging requirements of machine 102. EVSE 214 may communicate (via its network connectivity) charge states of PBS 104 and/or auxiliary battery 208, battery health of PBS 104 and/or auxiliary battery 208, as well as current output power of solar panels 202 (as reported to EVSE 214 by controller 218). For example, an off-site operator may query EVSE 214 to determine a current charge state of PBS 104.

As mentioned above, EVSE 214 may provide maintenance charging to machine 102. While a single connector 216 is shown in FIG. 2, it is possible that EVSE 214 may feature a plurality of connectors so that a single charger 200 may charge machines with different connectors (e.g., a first machine with CCS-1 and a second machine with CCS-2). It is also possible that EVSE 214 may feature interchangeable connectors.

### INDUSTRIAL APPLICABILITY

The charger 200 of the present disclosure may be used in any machine for which solar maintenance charging may be applicable. Charger 200 enables PBS 104 to be maintained at a given charge level for extended durations of time. For example, an operator may finish a workday with PBS 104 of machine 102 at a given battery percentage (e.g., 60%). The operator may deploy charger 200 to maintain PBS 104 at 60% when the operator intends to leave machine 102 for an extended period of time. When the operator returns after the extended period of time, PBS 104 will still be at a 60% charge, because charger 200 will have compensated for self-discharge of PBS 104. This may be helpful to keep machines off-grid for longer periods of time (e.g., avoiding the use of primary charging infrastructure). The relatively small size and output power of charger 200 bypasses the parasitic power requirements associated with primary charging infrastructure.

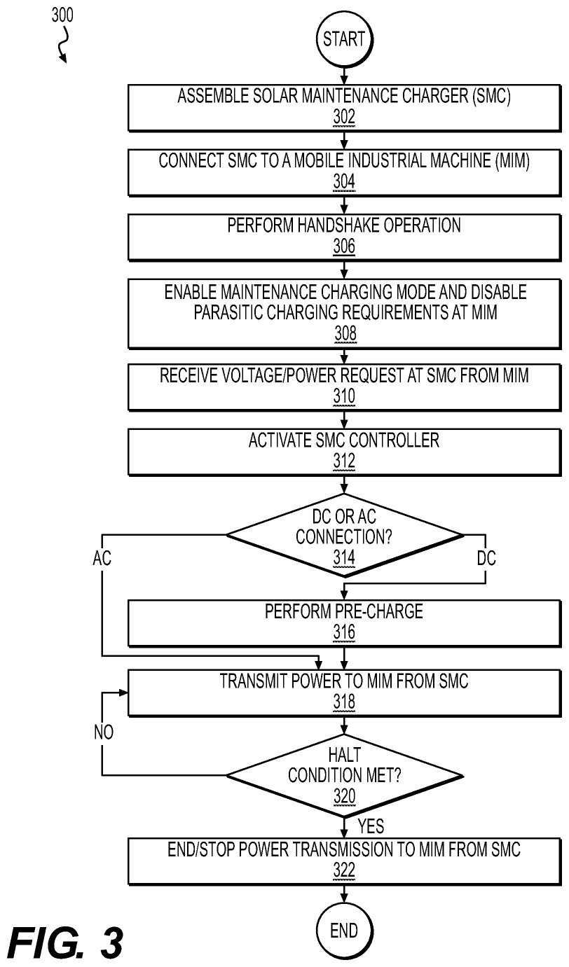

FIG. 3 provides a flowchart depicting an exemplary method for solar maintenance charging, according to aspects of the disclosure. In 310, an operator may assemble a solar maintenance charger (charger) (e.g., charger 200). This may include, for example, unfolding one or more flexible or foldable solar panels 202 from a compacted state to a larger use state. Assembly may also include placing the charger 200 atop a mobile industrial machine (machine, e.g., machine 102) such that the charger 200 may readily receive solar energy.

In 304, the operator may connect (e.g., via connection 216) the charger 200 to the machine 102 via a connector (e.g., a CCS connector).

In 306, the charger 200 and the machine 102 perform a handshake operation. The handshake operation may include multiple signals/messages exchanged between charger 200 and the machine 102. These signals may include information such as a machine 102 maximum power limit, a machine 102 maximum voltage limit, an charger 200 minimum available power limit, an charger 200 minimum available voltage limit, pre-charge confirmation signaling, and a continuous current request from the machine, requested at a rate of approximately 150 ms to 300 ms. During the handshake procedure 306, the machine 102 may identify itself to the charger 200 via the connection 216 and vice/versa. Handshake 306 may include an initial voltage of a primary battery system (PBS, e.g., PBS 104) of the machine 102. For example, the charger 200 may receive information that PBS 104 has an initial voltage corresponding to a 50% charge state. Handshake 306 may involve machine 102 communicating with EVSE 214. EVSE 214 may also communicate with controller 218

In 308, machine 102 enters a maintenance charging mode. The maintenance charging mode includes machine 102 disabling parasitic charging requirement and systems. This may include, for example, a cooling system associated with charging the PBS 104. Disabling parasitic charging requirements on the machine 102 allows charger 200 to maintain the charge of PBS 104. In typical charging scenarios, activation of these parasitic requirements (e.g., the cooling system) may exceed the available output power of charger 200.

In 310, machine 102 may transmit a power/voltage request to charger 200. It should be understood that machine 102 may have systems in place such that machine 102 may continuously monitor the battery charge state of PBS 104. For example, if PBS 104 drops below an initial voltage (corresponding to self-discharging), machine 102 may be aware of the change in voltage. If the voltage of PBS 104 drops below a certain threshold (for example, the initial voltage that machine 102 was left at following its most recent use), machine 102 may transmit a power/voltage request to charger 200.

In 312, charger 200 activates its controller 218. Controller 218 may direct the flow of power through various systems of charger 200.

In 314, EVSE 214 may determine whether an AC or DC connection has been made with machine 102. If it is an AC connection, charger 200 proceeds to 318. If it is a DC connection, the charger 200 proceeds to 316 and performs a pre-charge operation with machine 102. One of ordinary skill in the art will appreciate that initial connection of a battery to a load with capacitive input is followed by a surge of current as the capacitance of the load charges up to the voltage of the battery. This phenomenon, known as inrush current, may be limited by use of a precharge circuit. Thus, in operation 316, charger 200 provides a pre-charge with PBS 104 to prevent a current inrush.

In 318, charger 200 transmits power to machine 102. Power transmission 316 may be power transmitted from solar panels and/or power transmitted by auxiliary battery 208 (for example, during night time when solar panels 202 are not generating power). Several operations may be performed during power transmission 316. Charger 200 may convert received solar power at Vₚᵥ to V_{dc} via a converter (e.g., MPPT DC-DC converter 204). As an example, Vₚᵥ may be approximately equal to 50 V to 100 V. V_{dc} may be approximately equal to 400 V to 600 V. charger 200 may convert (via battery DC-DC converter 206) power at V_{dc} to V_{Bat_Aux}. V_{Bat_Aux} may be approximately 200 V to 300 V. charger 200 may convert, via battery DC-DC converter 206, power at V_{Bat_Aux} to V_{dc}. Charger 200 may convert power at V_{dc} to V_{Connector} via a high gain DC-AC converter 212. Power may be provided to converter 212 via solar panels 202 and/or auxiliary battery 208. High gain DC-AC converter may convert V_{dc} based on the type of connector in use, as well as the identification information supplied by the machine 102 during handshake 306. Power, current, and voltage exchanged between charger 200 and machine 102 may be based any information exchanged between charger 200 and machine 102 (such as information exchanged during the handshake).

In 320, machine 102 determines whether a halt condition has been met or satisfied. The halt condition may be based on machine 102 monitoring an electrical quantity, such as a voltage of PBS 104. In other aspects, machine 102 may refer to predefined tables/references to determine when the halt condition has been met. For example, machine 102 may be programmed to only perform maintenance charging a predefined number of times per day, or to only perform maintenance charging for specified time periods or at specific times of the day. It should be understood that halt conditions may be based on various factors and the aforementioned examples are only exemplary. Various sub-conditions may also be combined as a halt condition (for example, machine 102 may only charge twice a day, for a maximum of six hours). Upon satisfaction of the halt condition, power transmission is ended/stopped in 322. As part of the ending/stopping operation 322, machine 102 may transmit a signal to EVSE 214 via connection 216. The signal may inform EVSE to terminate further power transmission to machine 102. During periods of time that the machine 102 is not receiving power from charger 200, charger 200 may charge auxiliary battery 208.

One of ordinary skill in the art will appreciate that the method 300 shown in FIG. 3 may be repeated continuously while a machine 102 is not being used over extended periods of time (e.g., months). An operator returning to machine 102 will find PBS 104 at the same charge percentage as when it was left (e.g., 50%). In some aspects, PBS 104 may be maintained at a specified lower charge percentage than when it was left.

The disclosed system and method may facilitate solar maintenance charging operations. For example, the system and method may ensure that a primary battery system of a mobile industrial machine is kept at the same battery charge over long periods of downtime. The system and method may allow for machines to be charged by solar energy, without the use of parasitic power requirements of machines, such as cooling systems. The system and method may be implemented in a variety of fields that require maintenance charging, such as in the automotive, heavy industry, and energy storage fields, among other fields.

It will be apparent to those skilled in the art that various modifications and variations can be made to the disclosed system and method without departing from the scope of the disclosure. Other embodiments of the system and method will be apparent to those skilled in the art from consideration of the specification and system and method disclosed herein. It is intended that the specification and examples be considered as exemplary only, with a true scope of the disclosure being indicated by the following claims and their equivalents.

What is claimed is:

1. A solar maintenance charging kit, comprising:
a solar panel assembly;
an auxiliary battery system configured to receive power from the solar panel assembly; and
a electronics assembly configured to adjust a maintenance voltage supplied to a mobile industrial machine from one of the solar panel assembly or the auxiliary battery system, wherein the solar maintenance charging kit is portable.

2. The solar maintenance charging kit of claim 1, further comprising a connector for connecting the solar maintenance charging kit to the mobile industrial machine, wherein the connecting causes a mobile industrial machine to activate a maintenance charging mode.

3. The solar maintenance charging kit of claim 2, wherein the solar panel assembly has an output voltage of approximately 50 V to 100 V, wherein the auxiliary battery system has an output voltage of approximately 200 V to 300 V.

4. The solar maintenance charging kit of claim 2, wherein the electronics assembly further comprises:
a first converter, the first converter configured to convert power from the solar panel assembly from a first voltage to a second voltage; and
a second converter, the second converter configured to (i) convert power received from the first converter at the second voltage to a third voltage for the auxiliary battery system and (ii) convert power received from the auxiliary battery system from the third voltage to the second voltage.

5. The solar maintenance charging kit of claim 4, wherein the electronics assembly further comprises:
a third converter, wherein the third converter is configured to convert power received from at least one of the first converter or the second converter at the second voltage to a fourth voltage, wherein the fourth voltage corresponds to the mobile industrial machine and the connector.

6. The solar maintenance charging kit of claim 5, wherein the fourth voltage may be direct current (DC) or alternating current (AC).

7. The solar maintenance charging kit of claim 5 wherein the connector comprises a combined charging system (CCS) connector, wherein the solar panel assembly comprises flexible solar panels, wherein the third converter comprises a high gain converter.

8. A method for selectively charging a battery pack of a mobile industrial machine (MIM) with a solar maintenance charger (SMC), the SMC including a solar panel assembly, an electronics assembly, and an auxiliary battery system, wherein the SMC is portable, the method comprising:
connecting the SMC to the MIM via an electrical connector;
transmitting handshake information between the SMC and the MIM;
enabling a maintenance charging mode at the MIM;
transmitting a power request from the MIM to the SMC;
activating an electrical control unit at the SMC; and
disabling one or more parasitic power requirements of charging the battery pack, wherein the disabling further includes disabling a battery cooling system of the MIM.

9. The method of claim 8, further comprising:
supplying current from the solar panel assembly to the auxiliary battery system, wherein the supplying current from the solar panel assembly to the auxiliary battery system includes converting the current to a first voltage; and
supplying, based on the power request, current from the auxiliary battery system to the MIM, wherein the supplying current from the auxiliary battery system to the MIM includes converting the current to a second voltage.

10. The method of claim 9, wherein the first voltage is in a range of approximately 400 V to 600 V, wherein the second voltage is in the range of (i) approximately 300 V to 1000 V (ii) approximately 120 V or (iii) approximately 230 V.

11. The method of claim 9, further comprising:
determining, at the SMC, based on the handshake information, that the MIM requires direct current;
performing a pre-charge operation between the SMC and the battery pack;
determining, at the MIM, that a halt condition has been satisfied; and
terminating the supplying current from the auxiliary battery system to the MIM.

12. The method of claim 11, wherein the halt condition further comprises at least one of (i) a current voltage of the battery, (ii) a time of day, (iii) a total charging time within a predefined time period, or (iv) a total number of transmitted power requests transmitted within a predefined time.

13. The method of claim 9, further comprising:
supplying, based on the power request, current from the solar panel assembly to the MIM, wherein the supplying current from the solar panel assembly to the MIM includes converting the current to the second voltage.

14. The method of claim 8, wherein the handshake information further comprises at least one of (i) a MIM maximum power limit, (ii) a MIM maximum voltage limit, (iii) a SMC minimum available power limit, (iv) a SMC minimum available voltage limit, (v) a pre-charge confirmation signal, and (vi) a continuous current request from the MIM.

15. The method of claim 14, wherein the continuous current request is transmitted approximately every 150 ms to 300 ms.

16. The method of claim 8, wherein the power request further comprises a voltage request.

17. A method, comprising:
electrically connecting a solar maintenance charger (SMC) to a mobile industrial machine (MIM), the SMC comprising:
a solar panel assembly;
a first DC-DC converter, configured to convert power from the solar panel assembly from a first voltage to a second voltage;
a charging connector; and
a DC-AC converter, configured to convert power received from the first converter at the second voltage to a third voltage;
transmitting handshake information between the SMC and the MIM;
enabling a maintenance charging mode at the MIM;
transmitting a power request from the MIM to the SMC;
activating an electrical control unit at the SMC; and
supplying, based on the power request, current from the solar panels to the MIM, wherein the supplied current from the solar panel assembly to the MIM is at the third voltage.

18. The method of claim 17, wherein the handshake information further comprises at least one of (i) a MIM maximum power limit, (ii) a MIM maximum voltage limit, (iii) a SMC minimum available power limit, (iv) a SMC minimum available voltage limit, (v) a pre-charge confirmation signal, and (vi) a continuous current request from the MIM.

19. The method of claim 17, wherein the SMC further comprises:
a second DC-DC converter, configured to (i) convert power received from first converter at the second voltage to a fourth voltage for an auxiliary battery system of the SMC and (ii) convert power received from the auxiliary battery system of the SMC from the fourth voltage to the second voltage.

20. The method of claim 19, wherein the DC-AC converter is further configured to convert power received from the second converter from the second voltage to the third voltage.
